(19) United States
(12) Patent Application Publication
(10) Pub. No.: US 2010/0065643 A1
(43) Pub. Date: Mar. 18, 2010

(54) READING DEVICE AND METHOD FOR CODE MARKINGS ON RECEPTACLES

(76) Inventors: Philippe LEYVRAZ, Vevey (CH); René RUFFIEUX, Grenchen (CH)

Correspondence Address: OSTROLENK FABER GERB & SOFFEN, 1180 AVENUE OF THE AMERICAS, NEW YORK, NY, 100368403, US

(21) Appl. No.: 12/558,685

(22) Filed: Sep. 14, 2009

(30) Foreign Application Priority Data
Sep. 15, 2008 (EP) 08405226.5

(51) Int. Cl. G06K 7/10

(52) U.S. Cl. 235/470; 235/454

(57) ABSTRACT

Code reading device for receptacles with at least one code marking at a transparent or translucent circumferential wall section, said device comprising an illumination for applying light on said wall section and an image capturer for capturing image information of said code markings.

In a device, in order to avoid complicated handling or alignment of said receptacles before or during reading of said code markings, said illumination is adapted to provide light on at least three different light paths extending through said wall section and being relatively spaced such that the associated light incidence positions are disposed circumjacent to said wall section.

In a method, light is provided on at least three different light paths being relatively spaced such that the associated light incidence positions are disposed circumjacent to said wall section.

### FIELD OF THE INVENTION

The present invention relates to a code reading device for receptacles with at least one code marking at a transparent or translucent circumferential wall section, said device comprising an illumination for applying light on said wall section and an image capturer for capturing image information of said code markings. In particular, but not exclusively, the present invention relates to a reading device for code markings disposed in or on the side walls of glass receptacles as used in the pharmaceutical or chemical industry. Furthermore, the present invention relates to a method for reading at least one code marking provided at a transparent or translucent circumferential wall section of receptacles.

### BACKGROUND OF THE INVENTION

Patent application no. WO 2004/000749 A1 of the same applicant addresses the need of the pharmaceutical industry to provide medication with an individual code marking for allowing the tracing back of fabricated pharmaceuticals and discloses a method and a device for depositing code markings onto transparent glass receptacles. The method comprises engraving said code markings into the receptacle's glass walls by means of a laser light beam at a wavelength below 380 nm. Subsequently, the readability of each inscribed code marking has to be checked individually by a code reading means in order to allow immediate rejection of erroneous code markings before the filling of the receptacles takes place.

For integrating the code reading procedure into an industrial process flow, a fast and reliable identification of code markings is important while maintaining a large receptacle throughput. To meet these requirements the forecited method comprises successive inscribing and reading of each individual code marking, wherein each respective receptacle is directly moved from the laser inscribing system to the code reading means by a transport device. Thereby, a fast rotation and/or translation must be accomplished separately for each receptacle by said transport device, wherein previously inscribed code markings have to be provided at an accurately defined spatial reading position. This requires a complex mechanical manipulation for each receptacle, involving rather expensive and spacious equipment for transportation and spatial positioning.

### OBJECTS AND SUMMARY OF THE INVENTION

Accordingly, it is an objective of the present invention to provide an improved reading device and method for code markings on receptacles, wherein no complicated handling or alignment of said receptacles is required.

Relating to the code reading device, the invention suggests that said illumination is adapted to provide light on at least three different light paths extending through said circumferential wall section and being relatively spaced such that the associated light incidence positions are disposed circumjacent to said circumferential wall section. This allows for a reliable image-based reading of said code-markings due to the image information obtained by said image capturer based on received light stemming from at least one of said light paths, wherein complex positioning or rotating of said receptacles can be avoided.

Said image information may be gathered by said image capturer from light that is traversing said code markings and/or scattered and/or reflected by said code markings. Correspondingly, said image capturer may be adapted to receive outgoing light stemming from at least one of said light paths that is comprising an incident light portion that is extending towards the lateral and/or back and/or front side of the respective code marking position on said circumferential wall section. Furthermore, said image capturer may be adapted to receive light stemming from multiple light paths, e.g. scattered light stemming from one of said light paths and traversing light stemming from another of said light paths.

Preferably, said illumination is adapted to provide light successively on each of said light incidence positions, such that the respective illumination periods for each light incidence position are temporally shifted from one another. Thereby, interference effects stemming from light passing through two or more of said different light paths are effectively avoided. Advantageously, said illumination periods may be in a range of 0.1 ms to 100 ms for each of said light incidence positions.

Said temporal shifting of illumination periods for each of said light incidence positions may be achieved by alternating light application on said light paths. For instance, a strobe-like successive application of light pulses on each of said light paths is conceivable. Alternatively, said temporally shifted illumination periods may be provided by a spatial distribution of said light paths along a trajectory of movement of said circumferential wall section. In this case, light may be continuously applied on each of said light paths and said circumferential wall section may be moved relatively with respect to different light paths. Thus, the respective illumination period for each of said light incidence positions may be determined by the relative speed of movement of said wall section along said trajectory. In particular, a spiral shaped arrangement of said light paths around said trajectory is conceivable. It is understood, that also a combination of the two embodiments is conceivable, i.e. the application of strobe-like pulses and the relative movement of said wall section with respect to said light paths.

Advantageously, said light incidence positions are equally spaced along said circumferential wall section. Thereby, a maximum coverage of obtainable image information on said wall section is achievable. The obtainable image information may be further enhanced by increasing the number of light paths provided by said illumation means, wherein an odd number of different light paths is preferred. Particularly preferred are at least five different light paths provided by said illumation means.

According to a preferred embodiment, said illumination comprises at least one light source for each of said light paths, which allows an easy adjustment and control of each light path independently from one another. In order to provide cheap and reliable operation of light on said light paths, said light sources may be formed by light emitting diodes.

According to a further preferred embodiment, said image capturer comprises for each of said light paths at least one camera adapted for receiving light passing through said receptacle, in particular light that is traversing said code markings and/or scattered and/or reflected by said code markings, thus allowing independent image capturing for each light path. For instance, a CCD-camera may be disposed that is associated with each of said light paths. According to one embodiment, said light sources and said cameras may be arranged substantially opposite to one another for each of said light paths, thus allowing the registration of light substantially traversing said code markings. Furthermore, said cameras may be arranged laterally and/or aligned at a certain angle with respect to associated light sources, thus allowing the registration of light scattered and/or reflected by said code markings.

According to another preferred embodiment, said image capturer comprises for each of said light paths at least one deflector adapted for guiding the light passing through said receptacle to at least one common camera. Thereby, all image information from the different light paths may be captured by a single common camera, such that a costly employment of multiple cameras may be avoided.

According to an advantageous further development of a device according to the invention, said illumination and/or said image capturer are arranged substantially above or below the vertical length of said receptacles. Thereby, a horizontal movement and/or transportation of said receptacles towards and away from said code reading device can be easily achieved, wherein any movement of said device before, during or after the code reading procedure can be avoided. Thereby, the effect may be exploited that light is scattered and/or reflected by said code markings towards the top in case of an upper arrangement of said illumination or towards the bottom in case of an lower arrangement of said illumination, thus allowing said image capturer arranged at the top or bottom to gather image information from said scattered and/or reflected light.

According to a particularly preferred variant of such an upper or lower device arrangement with respect to the horizontal plane of receptacle movement, deflectors are provided for each of said light paths for guiding the light from said illumination to said circumferential wall section and/or from said circumferential wall section to said image capturer. Alternatively or auxiliary, said illumination may be arranged in such a way that an acute angle of incidence is provided on each of said light paths, thus allowing the disposal of said illumination below or above said receptacles.

According to another preferred embodiment of the invention, holders are provided for holding said receptacle in a fixed position during reading with respect to said illumination and said image capturer. Thereby, said light paths are preferably disposed concentrically with respect to the cross sectional area of said circumferential wall section in order to provide said circumjacent distribution of incident light with respect to the static position of said circumferential wall section.

According to an alternative preferred embodiment, a conveyor is provided for moving said receptacle during the reading procedure along a trajectory relative to said illumination and said image capturer, thus allowing reading of said code marking during transportation of said receptacles. Thereby, said light paths are preferably disposed in a spiral arrangement around said trajectory such that said circumjacent distribution of incident light with respect to said dynamically moved circumferential wall section is achieved. This may imply, that an incident portion of each of said light paths is arranged substantially perpendicular on a spiral shaped curve, wherein associated light sources and/or cameras may be provided at any distance from said spiral curve. In particular, said trajectory may exhibit a linear or a curved shape, wherein in the latter case said spiral arrangement of said light paths is adjusted to the given curvature.

According to a further preferred variant, said illumination comprises at least one light guiding means comprising an open end being disposable substantially inside said receptacles, wherein said light paths are provided by light deflection from said open end. Thus, a circumjacent distribution of respective light incidence positions is provided along the inner side wall of said circumferential wall section. For instance, said light guiding means may be a plexiglas light guide, wherein the tip of the guide is disposed inside said receptacles and acts as a mirror for light deflection towards the inner receptacle walls.

Relating to the method for code marking reading, the invention proposes that light is provided on at least three different light paths being relatively spaced such that the associated light incidence positions are disposed circumjacent to said wall section. Preferably, said light is provided successively on each of said light incidence positions, wherein the respective illumination periods are temporally shifted from one another.

Preferred applications of the invention comprise the reading of code markings such as data matrices, QR Codes, bar codes, clear-transparent texts and the like on receptacles such as syringes, flacons, ampuls, cartridges, bottles, vials and the like, in particular in the pharmaceutical, chemical or food industry.

### BRIEF DESCRIPTION OF THE DRAWINGS

The invention will be described in more detail in the following description of preferred exemplary embodiments with reference to the accompanying drawings. In the drawings:

FIG. 1a, b are illustrations of a receptacle with an examplary code marking at a transparent or translucent circumferential wall section;

FIG. 2 is a schematic representation of the geometry of a code reading device according to an embodiment of the invention in a top view, wherein an illumination and image capturer are disposed in a circular arrangement;

FIGS. 3 and 4 are schematic representations of the geometry of a code reading device according to further embodiments of the invention in a top view, wherein an illumination and image capturer are disposed in a spiral arrangement;

FIG. 5 to 7 are schematic representations of a code reading device according to further embodiments of the invention in a sectional side view, wherein an illumination and image capturer are arranged above the vertical length of the receptacle;

FIG. 8 is a schematic representation of a code reading device according to another embodiment of the invention in a sectional side view, wherein an illumination are arranged next to the vertical length of the receptacle;

FIG. 9 is a schematic representation of the geometry of a code reading device according to a further embodiment of the invention in a top view, wherein an illumination and image capturer are disposed in a spiral arrangement next to a transport path of the receptacle; and

FIG. 10 is a schematic representation of a code reading device according to another embodiment of the invention in a sectional side view, wherein a plexiglas light guide is disposed for guiding and deflecting light inside the receptacle.

### DETAILED DESCRIPTION OF THE PREFERRED EMBODIMENTS

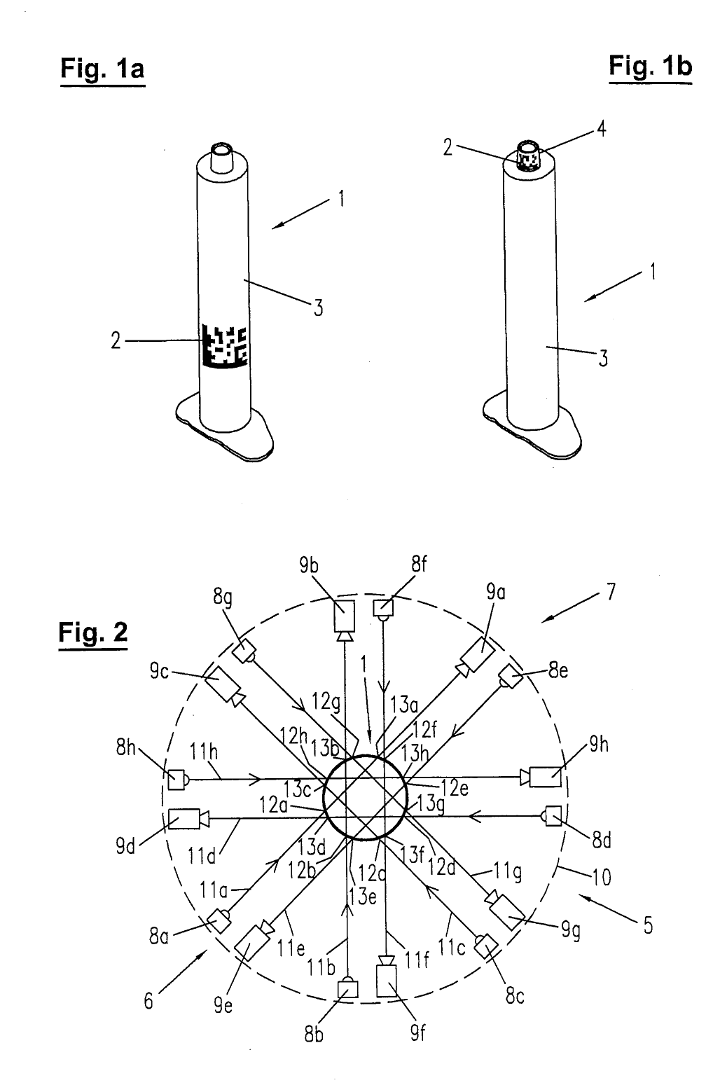

FIG. 1(a) depicts a transparent receptacle 1 in the form of a glass ampoule. A code marking 2 is provided at a circumferential wall section 3 in the lower range of the vertical length of receptacle 1. Said code marking 2 may be placed on the outer or inner surface of said circumferential wall section 3 or disposed inside the glass material. For instance, according to the method disclosed in prior art document WO 2004/000749 A1, said code marking 2 may be engraved inside the glass wall of receptacle 1 by employing a laser light beam at a wavelength below 380 nm. Correspondingly, FIG. 1(b) shows a code marking 2 provided at an upper circumferential wall section 4 of receptacle 1.

FIG. 2 schematically illustrates an embodiment of a code reading device 5 according to the invention comprising an illumination 6 for applying light on said transparent wall section 3, 4 of receptacle 1 and an image capturer 7 for gathering image information of said code marking 2. Said illumination 6 includes eight light sources 8a-8h that are arranged on an imaginary circle 10 and substantially equally spaced from one another. Said image capturer 7 includes eight cameras 9a-9h, each of which is arranged substantially opposite to one of said light sources 8a-8h on said circle 10. For instance, said light sources 8a-8h and said cameras 9a-9h may be fixed in a mutually opposed manner along the circumference of an annular body, e.g. on a disc or ring shaped mounting panel.

Said receptacle 1 is provided at a center portion with respect to the horizontal plane defined by said circle 10 such that said light sources 8a-8h and said cameras 9a-9h are perimetrically disposed around said receptacle 1. Thus, eight associated light paths 11a-11h are formed, each extending from one of said light sources 8a-8h through two opposed outer surface portions of said circumferential wall section 3, 4 of receptacle 1 and, thereby, corresponding light incidence positions 12a-12d and outgoing positions 13a-13h of said light paths 11a-11h are disposed, in a mutually opposed manner, circumjacent to said circumferential wall section 3, 4. In the case of light being scattered and/or reflected by said code marking 2, the respective outgoing position 13a-13h may vary with respect to the corresponding light incidence position 12a-12d. Light stemming from each of said light paths 11a-11h is then registered by one of said associated cameras 9a-9h.

Consecutively, a method for the reading of code markings 2 according to the above described code reading device 5 is explained. After transporting said receptacle 1 in its fixed position with respect to the center portion of circle 10, light is applied successively on each of said light paths 11a-11h by alternating operation of each of said light sources 8a-8h. The corresponding illumination periods on each light path 11a-11h may be in a range of 0.1 ms to 100 ms. Thereby, during a successive illumination process on each of said light paths 11a-11h, corresponding image acquisition comprising image information of said circumferential wall section 3, 4 at the respective light incidence position 12a-12d is carried out by said cameras 9a-9h. In particular, light scattered or reflected from said code markings 2 stemming from one of said light sources 8a-8h may be registered by any of said cameras 9a-9h. Due to successive light application on each of said light paths, interference effects stemming from light passing through a plurality of said light paths 11a-11h are effectively avoided. Subsequently, the gathered image information on each camera 9a-9h is evaluated with respect to said code marking 2. For instance, said receptacle 1 may be rejected if none of said acquired image information corresponds to a predetermined code marking information. Finally, said method is continued by positioning a successive receptacle 1 to the reading position at the center portion of circle 10.

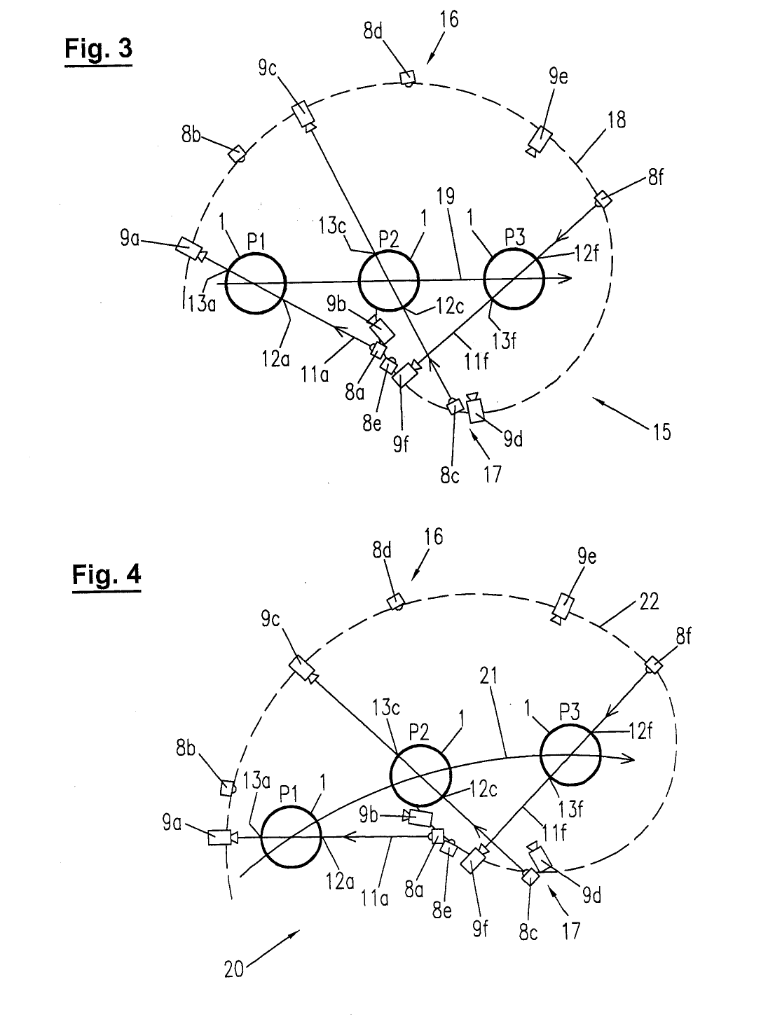

FIG. 3 schematically illustrates an alternative embodiment of a code reading device 15 according to the invention comprising an illumination 16 including six light sources 8a-8f arranged along an imaginary spiral curve 18. Each of said light sources 8a-8f is facing a respective camera 9a-9f disposed on said spiral curve 18 and constituting an image capturer 17. A straight-lined trajectory 19 for a linear movement of receptacle 1 is arranged in a center portion of said spiral curve 18. For instance, a linear transport of receptacle 1 may be achieved by means of a conveyor belt.

In a corresponding method, said receptacle 1 is moved along said trajectory 19. For the sake of illustration, FIG. 3 depicts receptacle 1 at three successive moving positions P1, P2 and P3 along said trajectory 19. During its movement, in particular at et each moving position P1, P2 and P3, said receptacle 1 successively crosses one respective imaginary connecting line between each of said light sources 8a-8f and its respective opposing camera 9a-9f. Preferably, light is continuously applied on each of said light sources 8a-8f. Thus, one respective light path 11a-11f is formed during each of said crossing, each extending from one of said light sources 8a-8f through respective opposing light incidence positions 12a-12f and outgoing positions 13a-13f on said circumferential wall section 3, 4 of receptacle 1 and registered by at least one of said cameras 9a-9f. Thereby, said light incidence positions 12a-12f of said light paths 11a-11f are disposed circumjacent to said circumferential wall section 3, 4, wherein interference effects stemming from light of different light paths 11a-11f are effectively avoided due to the time shifted successive crossing of each of said light paths 11a-11f.

FIG. 4 schematically illustrates a further embodiment of a code reading device 20 according to the invention. The structure of said device 20 basically corresponds to the structure of above discussed device 15 except for a curved trajectory 21 for a bended movement of receptacle 1. Thus, the arrangement of each of said light sources 8a-8f and the respective opposing camera 9a-9f is provided on an imaginary spiral curve 22 that is adapted to the curvature of trajectory 21 in order to provide said successive crossing of each of said light paths 11a-11h and said circumjacent arrangement of said light incidence positions 12a-12f during the curved movement of receptacle 1.

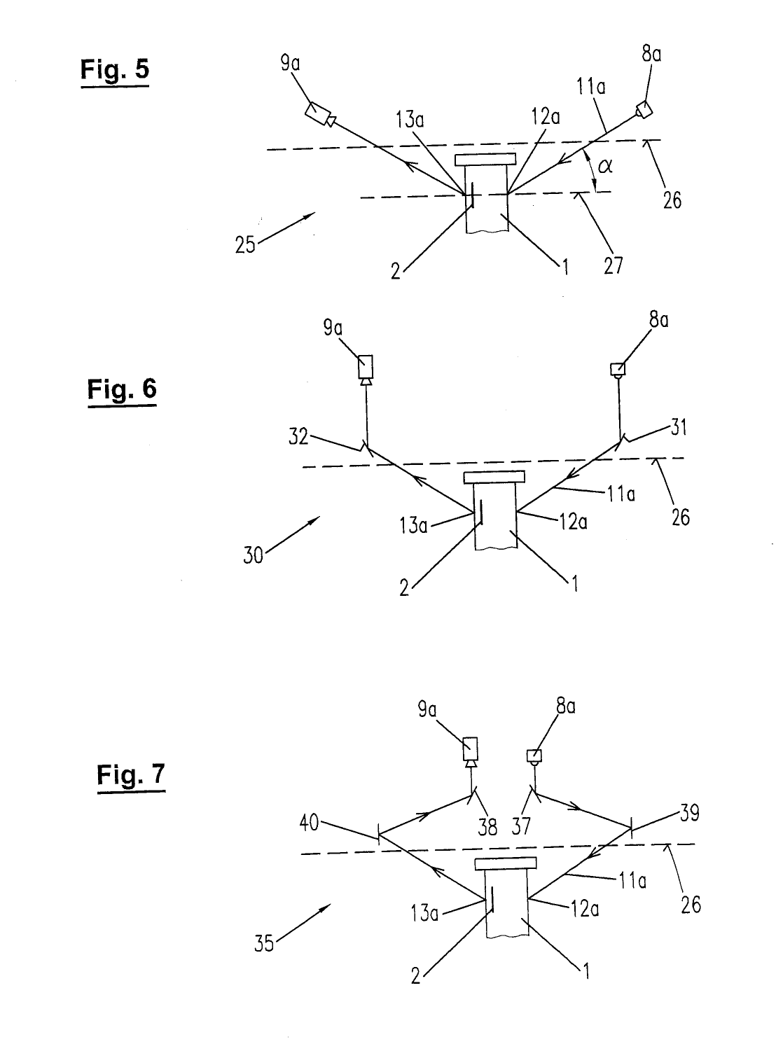

FIG. 5 depicts an embodiment of a code reading device 25 according to the invention in a sectional side view, wherein one of said light paths 11a extending from associated light source 8a through said circumferential wall section 3 of receptacle 1 to the respective opposing camera 9a is schematically illustrated. Thereby, said light source 8a and said camera 9a are arranged above an horizontal plane 26 which is disposed substantially above the vertical length of receptacle 1. Said light source 8a and said camera 9a are vertically tilted with respect to said horizontal plane 26. That way, an acute angle of incidence α is provided at an horizontal plane 27 extending perpendicular at the respective light incidence position 12a. The path section of outgoing light is continuing in an upward direction, for instance due to light scattering or reflection on code marking 2, and registered by camera 9a arranged above said horizontal plane 26. Thus, the horizontal transport of receptacle 1 into the reading position of said code marking 2 and/or during code marking reading can be accomplished below said upper horizontal plane 26 without any displacement of said code reading device 25.

FIG. 6 depicts another embodiment of a code reading device 30 in a sectional side view with said light source 8a and said camera 9a disposed above said horizontal plane 26 and each substantially directed towards the ground floor. Thereby, said acute angle of incident light α is provided by a respective tilted deflector 31 and the outgoing light is guided to said camera 9a by means of another tilted deflector 32. Said deflector 31, 32 are disposed essentially axially symmetrical above said horizontal plane 26 over said receptacle 1.

According to a preferred embodiment, said examplary light path 11a depicted in FIGS. 5 and 6 laterally represents the structure of each of said light paths 11a-11h depicted in FIG. 2-4 from a top view, wherein one of said light sources 8a-8h and one of said cameras 9a-9h is associated with each of said light paths 11a-11h.

FIG. 7 illustrates an alternative embodiment of a code reading device 35 in a sectional side view showing one examplary light path 11a and its associated light source 8a, wherein one common camera 9a is provided for each of said light paths 11a-f and associated light sources 8a-8f as depicted in FIG. 2-4. Thereby, one respective tilted deflector 37, 38 and one respective vertically arranged deflector 39, 40 is arranged in the incident and outgoing portion of each of said light paths 11a-f for guiding light from each of said light sources 8a-f to the respective circumjacent incidence position 12a-f and each of the respective outgoing light beams to said common camera 9a. This way, only one common camera 9a is required such that manufacturing costs of said code reading device 35 are reduced.

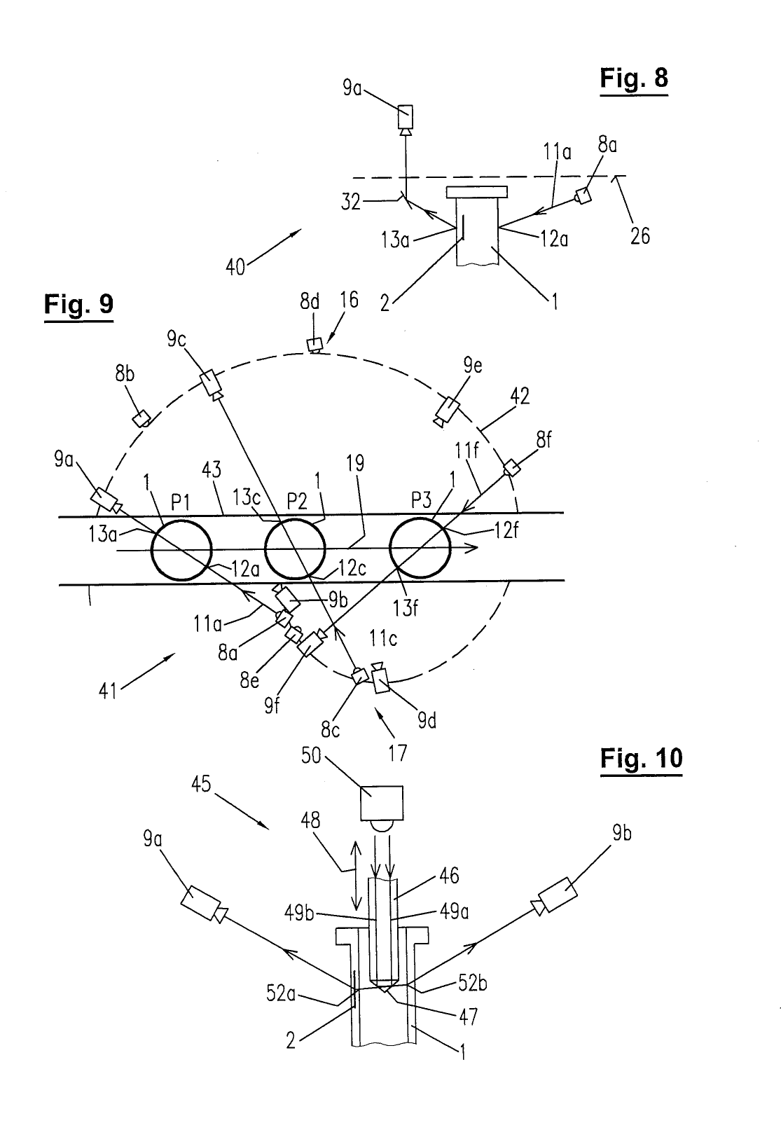

FIG. 8 shows a further embodiment of a code reading device 40 in a sectional side view, wherein said light source 8a and said deflector 32 for light deflection towards said camera 9a are disposed next to the vertical length of receptacle 1 below said upper horizontal plane 26.

FIG. 9 depicts a preferred embodiment of a code reading device 41 for which said lateral arrangement of light sources 8a-f and associated cameras 9a-f according to FIG. 8 next to the vertical length of receptacle 1 is conceivable. The principal structure of said device 41 basically corresponds to said code reading device 15 depicted in FIG. 3 such that said light sources 8a-f and associated cameras 9a-f are arranged along an imaginary spiral curve 42. Said spiral curve 42, however, is interrupted at a spatial area that is reserved for a transport channel 43 for said linear movement of receptacle 1 along said trajectory 19 implying that no light sources 8a-f and associated cameras 9a-f are disposed in that area. Thereby, associated light incidence positions 12a-12f may not be disposed equally spaced circumjacent to said circumferential wall section 3. Blind areas during code marking reading on said circumferential wall section 3 of receptacle 1 may be avoided, however, by an arrangement of light sources 8a, f and associated cameras 9a, f on a close portion of said interrupted spiral curve 42 with respect to said transport channel 43.

FIG. 10 depicts a further embodiment of a code reading device 45 in a sectional side view comprising a plexiglas light guide 46. The tip 47 of said plexiglas light guide 46 is movable along a vertical axis 48 inside receptacle 1 and acts as a mirror for light deflection towards the inner receptacle walls. Two examplary light paths 49a, b are depicted in FIG. 10, each extending from a common light source 50 arranged substantially above said light guide 46 to different deflection points 51a, b on said tip 43. Thereby, said tip 43 is acting as a mirror for light deflection towards the circumjacent light incidence positions 52a, b along the inner receptacle wall from which the outgoing portions of said light paths 49a, b are continued towards a respective camera 9a, b. Preferably, at least three different light paths 49a, b are provided by said light guide 46 resulting in a circumjacent distribution of respective light incidence positions 52a, b along the inner side wall of said circumferential wall section 3.

It should be understood that while certain variants of the present invention are illustrated and described herein, the invention is defined by the claims and is not to be limited to the specific embodiments described and shown. For example, although the specific embodiments described herein are applied on receptacles with a code marking on a circular circumferential wall section, said reading of code markings according to the invention is also conceivable on one or more code markings provided on non-circular and/or discontinous circumferential wall sections of receptacles.

Furthermore, although light paths exemplified in specific embodiments described herein linearly extend in one direction, variations are contemplated in which said light paths consist of several portions that are scattered or reflected in various directions. Said scattered or reflected light may be stemming from light paths with an incident portion extending substantially at the front or back side or laterally with respect to the position of said code markings on said circumferential wall section and may be registered by an associated camera disposed at the respective position of the outgoing portion of said light path of scattered light. Also it is conceivable that two or more different light paths are formed by a continuously expanded light beam of one light source and/or said circumjacent light incidence positions are not disposed at separated surface portions but continuously extend along said circumferential wall section.

What is claimed is:

1. A code reading device for receptacles with at least one code marking at a transparent or translucent circumferential wall section, said device comprising an illumination for applying light on said wall section and an image capturer for capturing image information of said code markings, wherein said illumination is adapted to provide light on at least three different light paths extending through said wall section and being relatively spaced such that the associated light incidence positions are disposed circumjacent to said wall section.

2. The code reading device according to claim 1, wherein said illumination is adapted to provide light successively on each of said light incidence positions, such that the respective illumination periods are temporally shifted from one another.

3. The code reading device according to claim 2, wherein said temporally shifted illumination periods are provided by alternating light application on said light paths.

4. The code reading device according to claim 2, wherein said temporally shifted illumination periods are provided by a spatial distribution of said light paths along a trajectory of said receptacle.

5. The code reading device according to claim 2, wherein said illumination periods are in a range of 0.1 ms to 100 ms for each of said light incidence positions.

6. The code reading device according to claim 1, wherein said light incidence positions are equally spaced along said circumferential wall section.

7. The code reading device according to claim 1, wherein said illumination comprises at least one light source for each of said light paths.

8. The code reading device according to claim 1, wherein said image capturer comprises at least one camera for each of said light paths adapted for receiving light passing through said wall section.

9. The code reading device according to claim 7, wherein for each of said light paths said light source and said camera are arranged substantially opposite to one another.

10. The code reading device according to claim 1, wherein for each of said light paths said image capturer comprises at least one deflector adapted for guiding light passing through said receptacle to at least one common camera.

11. The code reading device according to claim 1, wherein said illumination or said image capturer or both is arranged substantially above or below the vertical length of said receptacles.

12. The code reading device according to claim 1, wherein said illumination is arranged such that an acute angle of incidence is provided on each of said light paths.

13. The code reading device according to claim 1, further comprising a holder for holding said receptacle in a fixed position with respect to said illumination and said image capturer, wherein said light paths are disposed concentrically with respect to the cross sectional area of said circumferential wall section.

14. The code reading device according to claim 1, further comprising a conveyor for moving said receptacle along a trajectory relative to said illumination and said image capturer, wherein said light paths are disposed in a spiral arrangement around said trajectory.

15. The code reading device according to claim 14, wherein said trajectory is curved and said spiral arrangement of said light paths is adjusted to this curvature.

16. The code reading device according to claim 1, wherein said illumination comprises at least one light guiding means comprising an open end being disposable substantially inside said receptacles, wherein said light paths are provided by light deflection from said open end.

17. A method for reading at least one code marking provided at a transparent or translucent circumferential wall section of receptacles, wherein light is applied on said wall section and image information of said code marking is captured during illumination of said wall section, wherein said light is provided on at least three different light paths extending through said wall section and being relatively spaced such that the associated light incidence positions are disposed circumjacent to said wall section.

18. The method according to claim 17, wherein said light is provided successively on each of said light incidence positions, wherein the respective illumination periods are temporally shifted from one another.

19. The code reading device according to claim 8, wherein for each of said light paths said light source and said camera are arranged substantially opposite to one another.
